(19) United States
(12) Patent Application Publication
(10) Pub. No.: US 2018/0038934 A1
(43) Pub. Date: Feb. 8, 2018

(54) DISCRIMINATION OF SIGNAL ANGLE OF ARRIVAL USING AT LEAST TWO ANTENNAS

(71) Applicant: SR Technologies, Inc., Davie, FL (US)

(72) Inventors: Mark PASSLER, Boca Raton, FL (US); Graham K. SMITH, Boca Raton, FL (US)

(21) Appl. No.: 15/665,821

(22) Filed: Aug. 1, 2017

Related U.S. Application Data
(60) Provisional application No. 62/370,368, filed on Aug. 3, 2016.

(51) Int. Cl. G01S 3/32; H01Q 21/00

(52) U.S. Cl. CPC G01S 3/32; H01Q 21/00; H04B 17/318

(57) ABSTRACT

A method, apparatus and RF unit for determining true angles of arrival of a beam received at an antenna array having a pair of antenna elements are provided. In some embodiments, a method includes computing a sum signal based on a sum of signals received from the pair of antenna elements of the antenna array and computing a difference signal based on a first difference of the signals received from the pair of antenna elements of the antenna array. The method also includes computing one of: a ratio of the sum signal to the difference signal; and a second difference between the sum signal and the difference signal. The method also includes determining all possible angles of arrival of the beam based on the one of the ratio and the second difference and then determining the intersection of all the possible angles of arrival for each of the different positions in order to determine the true angles of arrival.

### CROSS-REFERENCE TO RELATED APPLICATION

This application is related to and claims priority to U.S. Provisional Patent Application Ser. No. 62/370,368, filed Aug. 3, 2016, entitled, “DISCRIMINATION OF SIGNAL ANGLE OF ARRIVAL USING AT LEAST TWO ANTENNAS”, the entirety of which is incorporated herein by reference.

### STATEMENT REGARDING FEDERALLY SPONSORED RESEARCH OR DEVELOPMENT

n/a

### TECHNICAL FIELD

The present disclosure relates to a method and system for antenna arrays and more specifically for determining an angle of arrival of a radio frequency (RF) wave using two RF antennas.

### BACKGROUND

Angle of arrival (AoA) measurement is a method for determining the direction of propagation of a radio-frequency wave incident on an antenna array. AoA determines the direction of the transmitted signal and may be determined by measuring the difference in received phase at each element in the antenna array.

FIG. 1 depicts a two element array. Antenna A 10, and antenna B 11, are spaced apart by a distance D. An incoming RF wave 12 (shown as RF signals 12a and 12b) is received at antenna A 10, and at antenna B 11. The incoming RF wave 12 is arriving at an angle θ 14 incident to the plane of the two antennas 10 and 11. The RF signal 12b received at antenna B 11 has travelled further than the RF signal 12a received at antenna A 10 by a distance d 15.

The extra distance travelled by the RF signal, d, is related to the distance between the antennas, D, and the angle of the arrival of the RF signal, θ; using simple geometry:

d=D cos θ (1)

The phase difference φ between the RF signal received at antenna B 11 and the RF signal received at antenna A 10 is:

φ=d/2πλ where λ is the wavelength of the RF signal. (2)

### Hence, φ=D cos θ/2πλ

cos θ=φ·2πλ/D

or

θ=cos⁻¹(φ·2πλ/D) (3)

The phase difference φ between the two RF signals received at each of the antennas is therefore related to the angle of arrival θ of the RF signal. For example, if the RF signal is coming from a direction directly in front of the two antennas then φ=0 and θ=90° or π/2 radians.

A common method to measure the phase difference φ is to add the signals from both antennas as depicted in FIG. 2. The output from each antenna 10 and 11 is connected to the inputs of an RF adder 21 which provides the sum of the two signals 22 at its output.

If the received signals at antennas 10 and 11 have amplitude A, then the output 22 of the RF adder 21, using simple trigonometry, is:

Sum=A\sqrt{2+2 cos φ} (4)

If the distance D between the antennas 10 and 11 is arranged to be half a wavelength, D=λ/2, then when the RF signal is coming from a direction from the side of the antennas, θ=0, the two RF signals from the two antennas will be in anti-phase and will cancel out and the result will be an RF signal of zero amplitude. When the RF signal is coming from the front of the two antennas, θ=π/2, then the two RF signals will add in phase and the result will be an RF signal at the maximum amplitude. FIG. 3 shows a graphical representation 30 of the amplitude of the RF signal 22 at the output of the RF adder 21 as the angle of arrival varies from 0 to 180 degrees.

FIG. 4 shows a graphical representation 40 of the amplitude of the RF sum signal 22 at the output of the RF sum block 21 plotted against angle of arrival as the angle of arrival varies from 0 to 180 degrees and when the distance D between the antennas 10 and 11 is set to one wavelength, D=λ. Note that the amplitude is at a maximum at angles of arrival 0, 90 and 180 degrees, and at a minimum at angles of arrival 60 and 120 degrees.

A common method to measure the angle of arrival is to rotate the two antennas around their axis such that the sum of the received signals is at a maximum and hence the direction of the incident wave is known. The accuracy of this approach can be increased by using two directional antennas or by increasing the distance between the two antennas which results in a narrower front beam width but also more than one maximum. A disadvantage of this approach is that the antenna assembly needs to be rotated, the accuracy is limited by the directionality of the individual antennas and to increase the directionality of the antenna the size of each antenna will increase. For example, the beam width of an antenna is related to the gain of the antenna; the narrower the beam width, the higher the gain. For example a patch antenna consists of a flat rectangular sheet or “patch” of metal, mounted over a larger sheet of metal called a ground plane. An example of a patch antenna at 2.4 GHz has a gain of about 8 dBi, a 3 dB beam width of about 60 degrees and has side lengths of about 4 inches. An array of 4 patch antennas, side by side, would be in the order of 16 inches in length, would have a horizontal beam width of about 20 degrees. Achieving a narrow beam width in the order of approximately 5 degrees would require a linear array of 16 patch antennas. This antenna array would have a length of about 64 inches.

### SUMMARY

Some embodiments advantageously provide a method, apparatus and RF unit for determining true angles of arrival of a beam received at an antenna array having a pair of antennas is provided. In some embodiments, a method includes, from a number of differing locations of the antenna array, computing a sum signal based on a sum of signals received from the pair of antenna elements of the antenna array and computing a difference signal based on a first difference of the signals received from the pair of antenna elements of the antenna array. The method also includes computing one of: a ratio of the sum signal to the difference signal; and a second difference between the sum signal and the difference signal. The method also includes determining possible angles of arrival of the beam based on the one of the ratio and the second difference. The method then determines an intersection of the possible angles of arrival for each of the different positions in order to determine the true angles of arrival.

According to this aspect, in some embodiments, the sum signal is a first received signal strength indicator (RSSI) derived from the sum of the signals and the difference signal is a second RSSI derived from the first difference of the signals. The method may also include the determined possible angles of arrival are based on the second difference. In some embodiments, the sum signal and the difference signal are computed in decibels. In some embodiments, the determination of the possible angles of arrival involves computing the sum signal and the difference signal at different positions of the antenna array. In some embodiments, the determination of the possible angles of arrival involves computing the sum signal and the difference signal based on signals received from different pairs of antenna elements of the antenna array. In some embodiments, the sum of signals is a first addition of a first output signal from a first antenna element of the pair of antenna elements shifted by zero degrees and a second output signal from a second antenna element of the pair of antenna elements shifted by zero degrees. In some embodiments, the method may also include the first difference of signals is a second addition of the first output signal from the first antenna element of the pair of antenna elements shifted by zero degrees and the second output signal from the second antenna element of the pair of antenna elements shifted by 180 degrees. In some embodiments, the sum of signals is a first addition of a first output signal from a first antenna element of the pair of antenna elements shifted by zero degrees and a second output signal from a second antenna element of the pair of antenna elements shifted by zero degrees. In some embodiments, the method may also include the first difference of signals is a second addition of the first output signal from the first antenna element of the pair of antenna elements shifted by 90 degrees and the second output signal from the second antenna element of the pair of antenna elements shifted by minus 90 degrees.

According to another aspect, an apparatus for determining true angles of arrival of a beam received at an antenna array having a pair of antenna elements is provided. The apparatus includes an adder configured to compute a sum signal based on a sum of signals received from a pair of antenna elements of the antenna array; a subtractor configured to compute a difference signal based on a first difference of the signals received from the pair of antenna elements of the antenna array; a processor configured to compute one of: a ratio of the sum signal to the difference signal; and a second difference between the sum signal and the difference signal. The apparatus also includes the processor further configured to determine possible angles of arrival of the beam based on the one of the ratio and the second difference. The apparatus then determines the intersection of the possible angles of arrival for each of the different positions in order to determine the true angles of arrival.

According to this aspect, in some embodiments, the sum signal is a received signal strength indicator (RSSI) derived from the sum of the signals and the difference signal is an RSSI derived from the first difference of the signals. The determined possible angles of arrival are based on the second difference. In some embodiments, the sum signal and the difference signal are computed in decibels. In some embodiments, determination of the possible angles of arrival involves computing the sum signal and the difference signal at different positions of the antenna array. In some embodiments, determination of the possible angles of arrival involves computing the sum signal and the difference signal based on signals received from different pairs of antenna elements of the antenna array. In some embodiments, the sum of signals is a first addition of a first output signal from a first antenna element of the pair of antenna elements shifted by zero degrees and a second output signal from a second antenna element of the pair of antenna elements shifted by zero degrees. In some embodiments, the first difference of signals is a second addition of the first output signal from the first antenna element of the pair of antenna elements shifted by zero degrees and the second output signal from the second antenna element of the pair of antenna elements shifted by 180 degrees. In some embodiments, the sum of signals is a first addition of a first output signal from a first antenna element of the pair of antenna elements shifted by zero degrees and a second output signal from a second antenna element of the pair of antenna elements shifted by zero degrees. The apparatus may also include the first difference of signals is a second addition of the first output signal from the first antenna element of the pair of antenna elements shifted by 90 degrees and the second output signal from the second antenna element of the pair of antenna elements shifted by minus 90 degrees.

According to some aspects, a radio frequency (RF) unit configured to determine true angles of arrival of a received beam is provided. The RF unit includes an antenna array having a plurality of antenna elements configured to receive the beam; a first input circuit coupled to a first one of a pair of antenna elements to produce a first signal; a second input circuit coupled to a second one of the pair of antenna elements to produce a second signal; and a processor configured to determine one of a first difference and a ratio between the first and second signals to determine possible angles of arrival of the beam. The processor is further configured to determine an intersection of the possible angles of arrival for each of different positions of the antenna array in order to determine the true angles of arrival.

According to this aspect, the first input circuit includes an adder to produce a sum of signals from the pair of antenna elements and the second input circuit includes a subtractor to produce a difference of signals from the pair of antenna elements. In some embodiments, the first input circuit includes a first splitter configured to split a first signal received by a first antenna element into a first branch signal shifted by 90 degrees and a second branch signal shifted by zero degrees. In some embodiments, the second input circuit includes a second splitter configured to split a second signal received by a second antenna element into a third branch signal shifted by 90 degrees and a fourth branch signal shifted by zero degrees. In some embodiments, the first input circuit further includes a first combiner configured to combine the first and fourth branch signals to produce a fifth signal having a sum of the first and second signals from the first and second antenna elements; and the second input circuit further includes a second combiner configured to combine the second and third branch signals to produce a sixth signal having a difference of the first and second signals from the first and second antenna elements. In some embodiments, the first input circuit further includes a first receiver to produce a first received signal strength indicator (RSSI) based on the fifth signal; and the second input circuit further includes a second receiver to produce a second RSSI based on the sixth signal. In some embodiments, the processor is configured to determine a second difference between the first RSSI and the second RSSI.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 depicts a two element array spaced apart by a distance of D;

FIG. 2 shows a common method to measure the phase difference by addition of the signals from both antennas;

FIG. 3 shows a graphical representation of the amplitude of the RF signal at the output of the RF summation block as the angle of arrival varies from 0 to 180 degrees;

FIG. 4 shows a graphical representation of the amplitude of the RF sum signal at the output of the RF sum block plotted against angle of arrival as the angle of arrival varies from 0 to 180 degrees and when the distance D between the antennas is set to one wavelength, D=λ;

FIG. 5 is a schematic diagram describing an embodiment of the disclosure where, in addition to deriving the sum of the two incident waves, the difference between the received signals at the two antennas is taken;

FIG. 6 is a graphical representation of the sum and the difference signals plotted against angle of arrival when the separation between the two antenna, is one wavelength;

FIG. 7 is a block diagram of an embodiment of the disclosure where two RF receivers, are used to measure the sum and difference signal strengths;

FIG. 8 is a graphical representation of the sum, difference and DIFF values plotted against angle of arrival when the amplitude of the incident signal A=−70 dBm, and the separation of the two antennas, is one wavelength, i.e. D=λ;

FIG. 9 is a graphical representation of the sum, difference and DIFF values plotted against angle of arrival, when the amplitude of the incident signal A=−80 dBm, and the separation of the two antennas, is one wavelength, i.e. D=λ;

FIG. 10 is a graphical representation of the DIFF in dB, and the slope of the DIFF in dB/degree plotted against angle of arrival;

FIG. 11 is a graphical representation of the DIFF in dB, plotted against angle of arrival;

FIG. 12 is a diagram depicting an exemplary usage of the disclosure where the antenna array and angle of arrival measuring receiver is shown in three positions;

FIG. 13 is a diagram depicting an exemplary usage of the disclosure with common combining elements used in each path;

FIG. 14 is a graphical representation of the signal C, signal D and DIFF values plotted against angle of arrival, when the amplitude of the incident signal A=−80 dBm, and the separation of the two antennas 10 and 11, is one wavelength, i.e. D=λ;

FIG. 15 is a graphical representation of the DIFF in dB, and the slope of the DIFF in dB/degree plotted against angle of arrival for DIFF derived from signal C and D;

FIG. 16, FIG. 17, FIG. 18 and FIG. 19 are graphical representations of the DIFF signal and the slope plotted against the angle of arrival, for various antenna separations;

FIG. 20 is a graphical representation of the gain of a standard patch antenna against the angle of arrival;

FIG. 21 is a diagrammatic representation of a system comprising two patch antennas, 2-way 90 degree splitters, and 2-way 0 degree combiners;

FIG. 22 is a graphical representation of the signal C, signal D, DIFF and calculated input signal values plotted against angle of arrival, when the amplitude of the incident signal A=−80 dBm, and the separation of the two patch antennas is one wavelength, i.e. D=λ;

FIG. 23 illustrates a method according to an embodiment of the disclosure; and

FIG. 24 is a flowchart of an exemplary process for determining an angle of arrival.

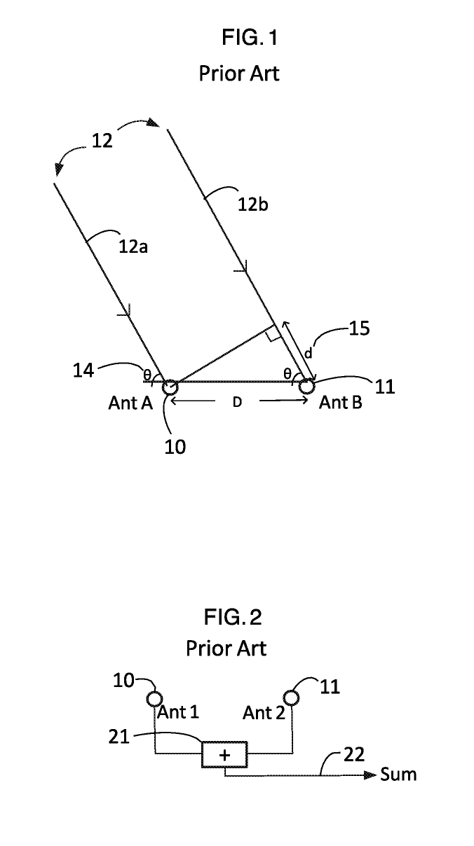

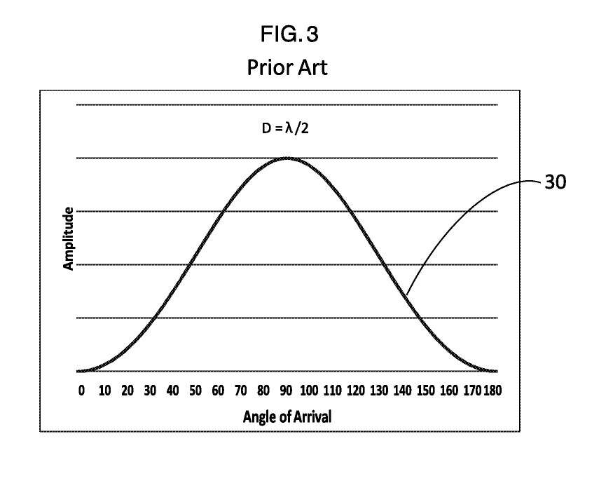

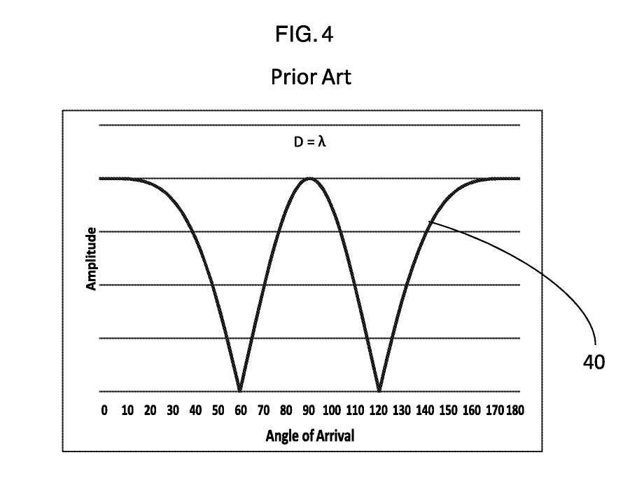

### DETAILED DESCRIPTION

This disclosure relates to the discrimination of signal angle of arrival by ratio of oppositely phased combinations of signals from two antennas.

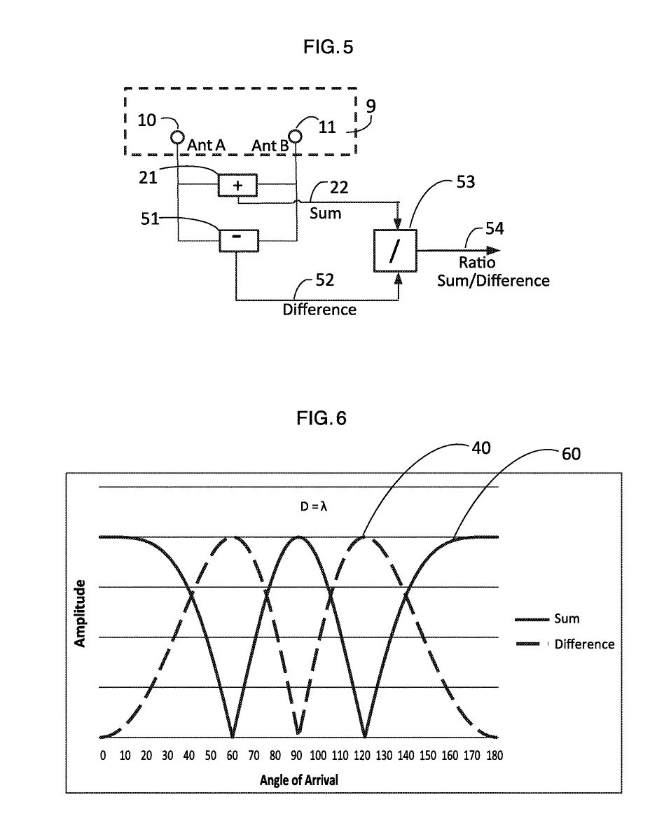

FIG. 5 is a schematic diagram describing an embodiment of the disclosure. Referring to FIG. 5, in addition to deriving the sum of the two incident waves, the difference between the received signals at the two antennas 10 and 11 of an antenna array 9 is derived. The output from each antenna 10 and 11 is connected to the inputs of an RF adder 21 which provides the sum of the two signals 22 at its output. The output from each antenna 10 and 11 is also connected to the inputs of an RF subtractor 51 which provides the difference of the two signals 52 at its output. The ratio of the sum signal 22 and the difference signal 52 is then derived in block 53. The ratio of the sum and difference signals 54 is then outputted from block 53.

If the received signals at antennas 10 and 11 have amplitude A, then the output of the RF difference block 52, using simple trigonometry, can be shown to be:

Difference=A\sqrt{2−2 cos φ} (5)

Hence the ratio 54 is:

$$\begin{matrix}Sum / Difference = \frac{\sqrt{2} A \sqrt{1 + cos φ}}{\sqrt{2} A \sqrt{1 - cos φ}} & ( 6 ) \\ Sum / Difference = \frac{\sqrt{1 + cos φ}}{\sqrt{1 - cos φ}} & ( 7 )\end{matrix}$$

Note that the ratio formula (7) is independent of the amplitude A of the incident signal.

FIG. 6 is a graphical representation of the sum 40 and the difference 60 signals plotted against angle of arrival when the separation between the two antenna, 10 and 11, is one wavelength. As can be seen, the ratio sum/difference is at a maximum at 0, 90 and 180 degrees (where the sum is at a maximum and the difference is zero) and at a minimum at 60 and 120 degrees (where the sum is zero).

In practice, the actual measurement of the amplitudes of the sum and difference signals may be performed by an RF receiver. It is common practice for an RF receiver to measure the received signal strength of an RF input signal. This value is commonly referred to as the received signal strength indicator (RSSI) and is usually expressed in dBm.

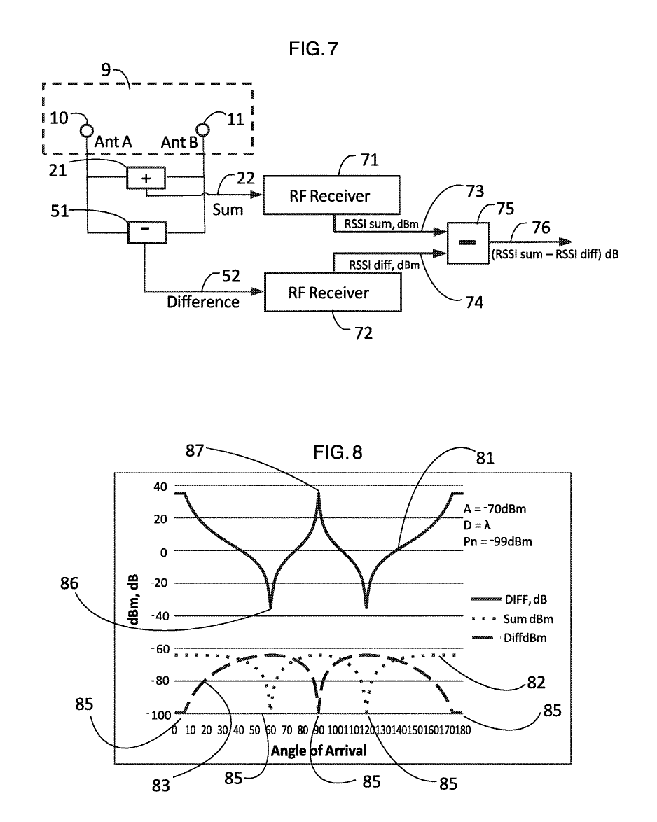

FIG. 7 is a block diagram of an embodiment of the disclosure where two RF receivers, 71 and 72 are used to measure the sum and difference RF signal strengths, 22 and 52, respectively. The RSSI 73 of the sum signal 22 is measured by RF receiver 71 and the RSSI 74 of the difference signal 52 is measured by RF receiver 72. As the RSSI values are in dBm, the ratio of the sum and difference signals, in dBs, 76, is determined by simple subtraction of the two values, 73 and 74 in block 75. This subtraction value, in dBs, of the sum and difference dBm values will be referred to as DIFF. In practice the subtraction carried out in block 75 may be an operation carried out by a processor.

FIG. 8 is a graphical representation of the sum 82, difference 83 and DIFF 81 values plotted against angle of arrival when the amplitude of the incident signal A=−70 dBm, and the separation of the two antennas 10 and 11, is one wavelength, i.e. D=λ. The sum 82 and the difference 83 is displayed in dBm, and the DIFF is displayed in dBs. The minimum value for the sum and difference signal strengths, 85 in five positions, is limited by the noise floor of the receiver. In this example, the noise floor is assumed to be −99 dBm hence the minimum value 85 is limited to −99 dBm. It should be noted that in general the measurement of RSSI by an RF receiver will be in integers of one decibel, this has been observed in all the calculations used to produce the presented graphical figures.

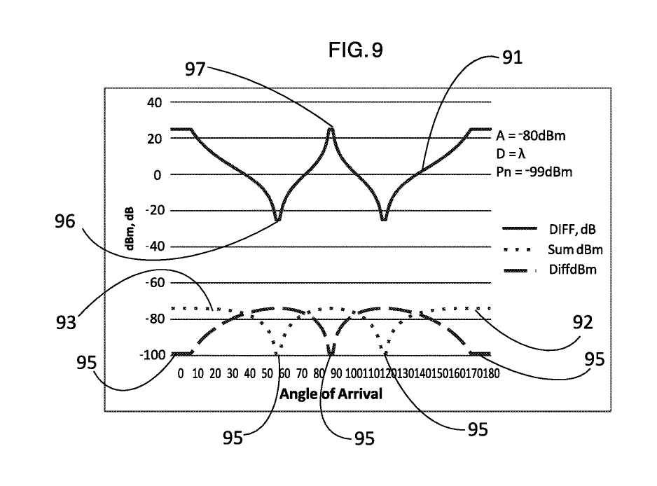

FIG. 9 is a graphical representation of the sum 92, difference 93 and DIFF 91 values plotted against angle of arrival, when the amplitude of the incident signal A=−80 dBm, and the separation of the two antennas 10 and 11, is one wavelength, i.e. D=λ. The noise floor is again assumed to be −99 dBm hence the minimum value 95 (five positions) is limited to −99 dBm. It may be noted that because of the lower amplitude of the input signal, the maximum and minimum values, 97 and 96 respectively, of the DIFF, 91, are less than the maximum and minimum values of the DIFF, 87 and 88 respectively as shown in FIG. 8 where the input signal amplitude is −70 dBm. However, it should be noted that with the exception of this effective flattening of the DIFF value at the narrow range of values where the minimum values for the sum and difference signals are limited by the noise floor of the receiver, the value of the DIFF is identical between FIG. 8 and FIG. 9. Hence, as predicted by formula (7), the DIFF value is effectively independent of the amplitude of the input signal.

FIG. 10 is a graphical representation of the DIFF 91 in dB, and the slope of the DIFF 100 in dB/degree plotted against angle of arrival. The vertical axis 101 for the slope is on the right hand side of the graph. For angles of arrival between 50 and 130 degrees the slope is in the order of 1 dB/degree or higher. Therefore, in theory, as the DIFF measurement is in increments of 1 dB, then the accuracy of the measurement of the angle of arrival is in the order of 1 degree over the range 50 to 130 degrees, and better than 2 degrees over the range 10 to 170 degrees. In practice a variation of ±1 dB may be expected in the RSSI measurements of the sum and difference signals, which would result in a variation of ±2 dB in the DIFF measurement, equivalent to about ±2 degrees accuracy which may be improved by averaging the result over time. This accuracy is equivalent to the use of highly directional antennas which would have correspondingly relatively large dimensions.

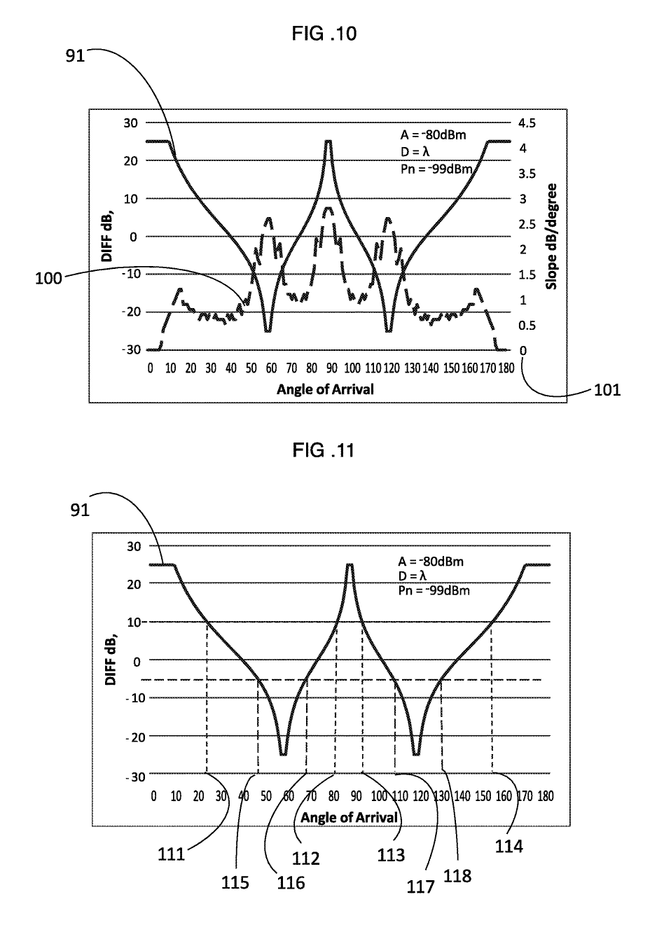

FIG. 11 is a graphical representation of the DIFF 91 in dB, plotted against angle of arrival. For each measured value of DIFF in general, in this example, there will be four possible angles of arrival. For example, in FIG. 11 the value of 10 dB for DIFF is illustrated. There are four possible angles of arrival, 25 degrees 111, 85 degrees 112, 95 degrees 113, and 155 degrees 114, which could result in a value of 10 dB for DIFF. Also, as another example, for a DIFF value of −5 dB, there are four possible angles of arrival, 49 degrees 115, 70 degrees 116, 110 degrees 117, and 131 degrees 118. Similarly, for a DIFF value of −12 dB there are four possible angles of arrival, 55 degrees, 65 degrees, 115 degrees, and 125 degrees.

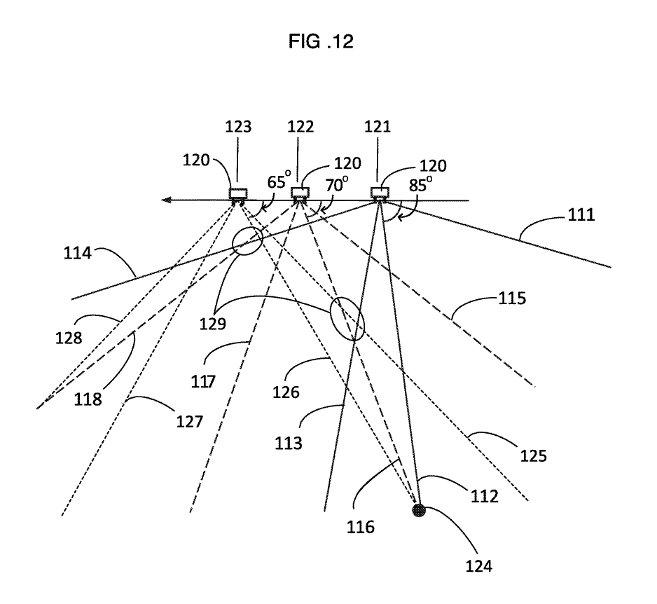

FIG. 12 is a diagram depicting an exemplary usage of the principles and methods described herein. The angle of arrival measuring receiver 120 is shown in three positions, 121, 122 and 123. The target transmitter is positioned at point 124 such that the angle of arrival at the measuring receiver 120, when in position 121, is 85 degrees. In this case, as shown in FIG. 11, at the measuring receiver 120 the DIFF value will be 10 dB and hence the possible angles of arrival are 25 degrees 111, 85 degrees 112, 95 degrees 113, and 155 degrees 114. When the measuring receiver 120 is at position 122, the angle of arrival of the transmissions from the target transmitter at point 124 is 70 degrees. In this case, as also shown in FIG. 11, at the measuring receiver 120 the DIFF value will be −5 dB and hence the possible angles of arrival are 49 degrees 115, 70 degrees 116, 110 degrees 117, and 131 degrees 118. When the measuring receiver 120 is at position 123, the angle of arrival of the transmissions from the target transmitter placed at point 124 is 65 degrees. As shown in FIG. 12, there are three sets of four lines depicting the twelve angles of arrival: set one, 111, 112, 113, and 114 corresponding to when the measuring receiver 120 is at position 121; set two 115, 116, 117, and 118 corresponding to when the measuring receiver 120 is at position 122; and, set three 125, 126, 127 and 128 corresponding to when the measuring receiver 120 is at position 123. There is only one point 124 where three lines, one from each set, intersect. Hence, by measuring the angles of arrival at three points 121, 122 and 123, only one solution for the intersection of the sets of angles results. Note that there are two areas, 129, where three lines are close to intersecting. These intersections can be ignored and the true intersection determined by using information that relates to a known dimension of the true location. For example it can be observed that the two close intersections are at much closer locations to the measuring receiver(s) and it is known that the target being located is situated at ground level. In this manner, the four possible solutions that result from a measurement at a single point, are resolved as the measuring receiver 120 moves and, knowing the positions of the measuring receiver, the position of the target 124 can be calculated.

Alternatively, instead of moving the measuring receiver 120, three, or more independent receivers may be used either in fixed positions or indeed, mobile. Hence, using a mobile receiver, or multiple receivers, even though each angle of arrival measurement produces four possibly solutions, the true solution is quickly determined due to the spatial geometry, as depicted and explained in FIG. 12.

The method of taking the ratio of the two signals produced by combining the outputs from two antennas is such that there are several manners in which combinations and methods of combining can be enabled. For example, the ‘sum’ signal is the addition of the output signal from antenna A 10 shifted by zero degrees, and the output signal from antenna B 11 shifted by zero degrees, and the ‘difference’ signal can be the addition of the output signal from antenna A 10 shifted by zero degrees, and the output signal from antenna B 11 shifted by 180 degrees. Similarly the ‘difference’ signal could be produced by the addition of the output signal from antenna A 10 shifted by 90 degrees, and the output signal from antenna B 11 shifted by −90 degrees. In fact any symmetrical and opposite shifting of the antenna output signals can be used but the optimum results are achieved when the shifts are in increments of 90, 180 or 270 degrees. In addition, in order to keep the differential losses and phases of the combining circuitry to a minimum, the connecting lines should be of equal lengths and common combining elements in each path should be used.

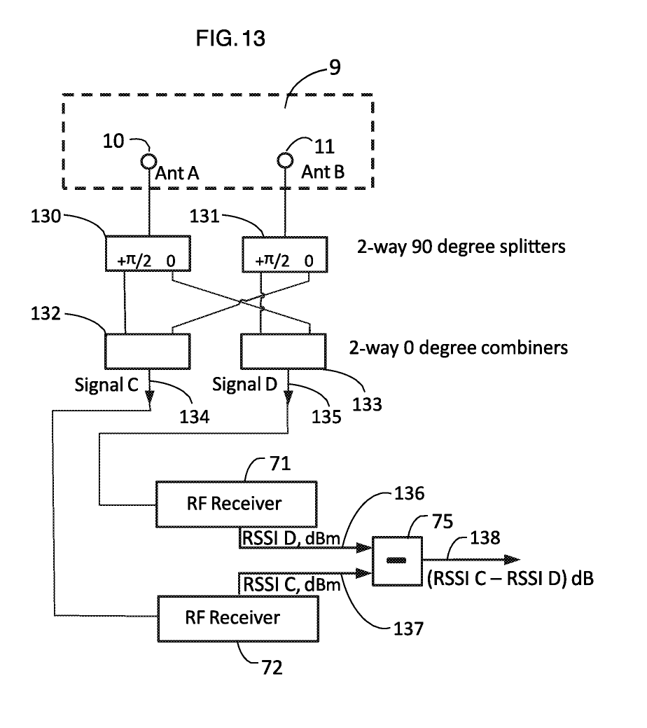

FIG. 13 is a diagram depicting an exemplary implementation with common combining elements used in each path. Antenna A 10 and antenna B 11 of an antenna array 9 are each applied to the input of a 2-way 90 degree splitter, 130 and 131 respectively. The +90 degree output from splitter 130 is connected to one input of a 2-way 0 degree combiner 132. Similarly, the +90 degree output from splitter 131 is connected to one input of a 2-way 0 degree combiner 133. The 0 degree output from splitter 130 is connected to the other input of combiner 133 whereas the 0 degree output from splitter 131 is connected to the other input of combiner 132. Hence the signal C 134 at the output of splitter 132 is the sum of the signal from antenna A 10 shifted by +90 degrees, and the signal from antenna B 11 shifted by 0 degrees. Similarly, the signal D 135 at the output of splitter 133 is the sum of the signal from antenna A 10 shifted by 0 degrees, and the signal from antenna B 11 shifted by +90 degrees. Signal C 134 is input to RF receiver 72 and signal D is input to RF receiver 71. The RSSI 136 for signal C 134, is measured and outputted by RF receiver 72, whereas the RSSI 137 for signal D 134, is measured and outputted by RF receiver 71. In block 75, the two RSSI values are subtracted to produce the DIFF signal 138. In practice the subtraction carried out in block 75 may be an operation carried out by a processor or processor circuitry including a processor and memory. 2-way 90 degree splitters are standard RF components and are well known, and similarly 2-way 0 degree RF combiners are also standard RF components and are well known. As such these components may be fabricated on a printed circuit board, be components soldered or mounted on a printed circuit board, or be coaxial devices connected by RF cables. In FIG. 13 the lengths of the four RF connections between the splitters and the combiners are generally set to be of equal length so as make the losses and phases symmetrical.

The signals C 134 and D 135 are different from the sum and difference values previously shown. In this case the relevant formulas are:

$$\begin{matrix}Signal C = A \sqrt{2 + 2 sin φ} & ( 8 ) \\ Signal D = A \sqrt{2 - 2 sin φ} & ( 9 ) \\ Ratio C / D = \frac{\sqrt{1 + sin φ}}{\sqrt{1 - sin φ}} & ( 10 )\end{matrix}$$

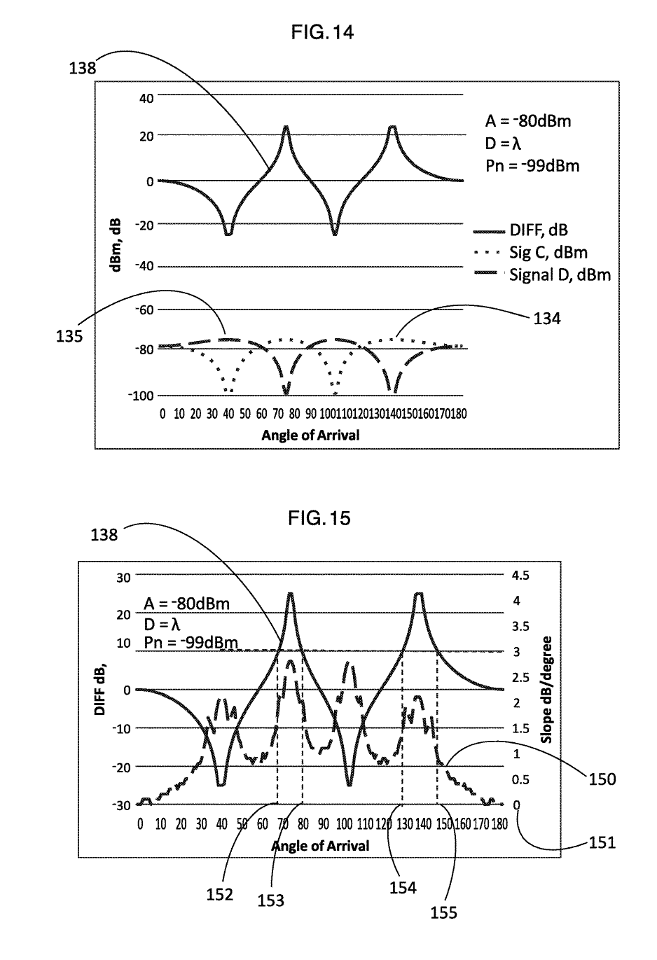

FIG. 14 is a graphical representation of the signal C 134, signal D 135 and DIFF 138 values plotted against angle of arrival, when the amplitude of the incident signal A=−80 dBm, and the separation of the two antennas 10 and 11, is one wavelength, i.e. D=λ. FIG. 14 may be compared to FIG. 9 where the sum and difference signals are depicted. The DIFF values 138, derived from signals C 134 and D 135 are essentially the same as when the sum and difference signals, 92 and 93 respectively, are used but shifted by 90 degrees as predicted by formulas (8), (9) and (10).

FIG. 15 is a graphical representation of the DIFF 138, in dB, and the slope of the DIFF 150 in dB/degree plotted against angle of arrival. The vertical axis 151 for the slope is on the right hand side of the graph. FIG. 15 may be compared to FIG. 10. For angles of arrival between 40 and 140 degrees the slope is still in the order of 1 dB/degree or higher.

Again, for each measured value of DIFF in general there will be four possible angles of arrival. Similar to the example shown in FIG. 11 the value of 10 dB for DIFF is illustrated and again there are four possible angles of arrival, in this case seventy degrees 152, eighty-one degrees 153, one hundred thirty-one degrees 154, and one hundred forty-eight degrees 155. Hence the combining of the antenna signals using the scheme depicted in FIG. 13 yields the same effective results with respect to slope and number of angles of arrival per DIFF value, as when using the sum and difference antenna signals as depicted in FIG. 7.

The example of spacing the antennas by one wavelength, D=λ, has been generally used to this point. However, the method of shifting and combining the signals from two antennas, as described, can be used with many antenna separations. As the distance between the antennas is varied, the resulting slope of the DIFF signal and the number of possible angles of arrival per DIFF value will vary.

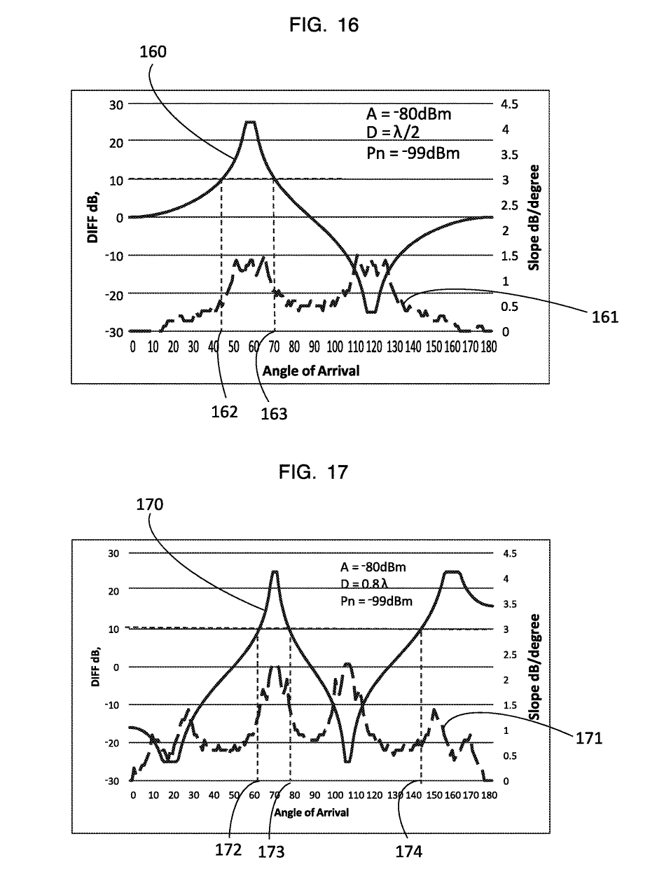

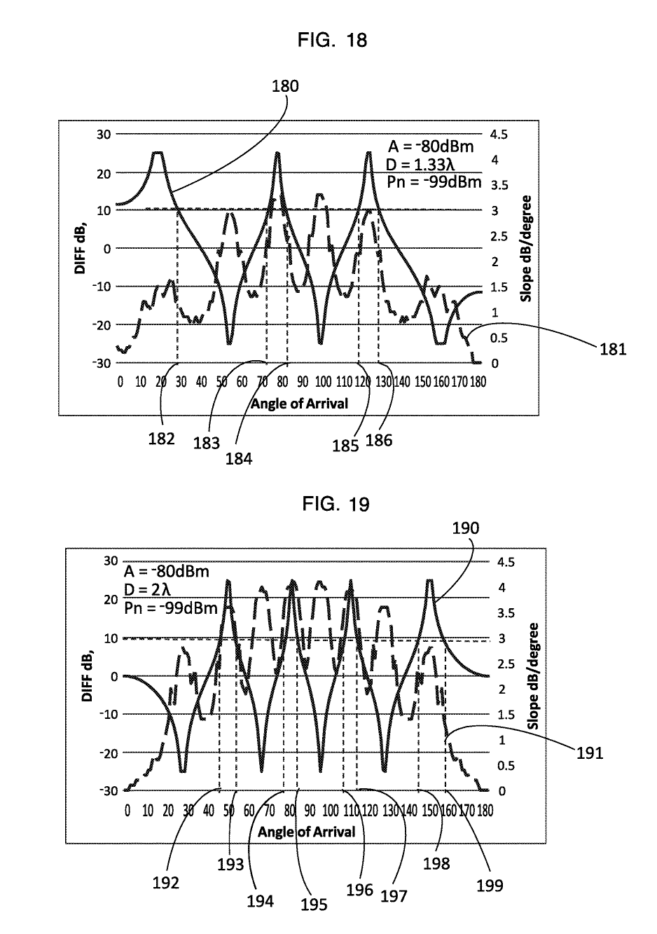

FIG. 16, FIG. 17, FIG. 18 and FIG. 19 are graphical representations of the DIFF signal and the slope plotted against the angle of arrival, for various antenna separations. The shifting and combining scheme as depicted in FIG. 13 has been used for these figures. In each case a signal amplitude A of −80 dBm and a noise floor of −99 dBm has been assumed. FIG. 16 is a graphical representation of the DIFF signal 160 and the slope 161 plotted against the angle of arrival, for an antenna separation of half a wavelength, D=λ/2. The slope is better than 0.5 dB per degree over the range 45 to 135 degrees angle of arrival, or 2 degrees per dB and in general there are two possible values for the angle of arrival for any DIFF value. The example of a DIFF value of 10 dB is shown that results in the two possible angles of arrival 162 and 163.

FIG. 17 is a graphical representation of the DIFF signal 170 and the slope 171 plotted against the angle of arrival, for an antenna separation D=0.8λ. The slope is better than that depicted in FIG. 16, in the order of 0.75 dB per degree or better, and in the order of 1.5 degrees per dB over the range 20 to 170 degrees, but in general there are now three possible values for the angle of arrival for any DIFF value. The example of a DIFF value of 10 dB is shown that results in the three possible angles of arrival 172, 173 and 174.

FIG. 18 is a graphical representation of the DIFF signal 180 and the slope 181 plotted against the angle of arrival, for an antenna separation D=1.33λ. The slope is better than that depicted in FIG. 17, in the order of 1.5 dB per degree or better, in the order of 0.66 degrees per dB or better, over the range 50 to 130 degrees, but in general there are now five possible values for the angle of arrival for any DIFF value. The example of a DIFF value of 10 dB is shown that results in the five possible angles of arrival 182, 183, 184, 185 and 186.

FIG. 19 is a graphical representation of the DIFF signal 190 and the slope 191 plotted against the angle of arrival, for an antenna separation D=2λ. The slope is better than that depicted in FIG. 18, in the order of 2 dB per degree or better, in the order of 0.5 degrees per dB or better, over the range 45 to 135 degrees, but in general there are now eight possible values for the angle of arrival for any DIFF value. The example of a DIFF value of 10 dB is shown that results in the eight possible angles of arrival 192, 193, 194, 195, 196, 197, 198 and 199.

It is possible therefore to increase the accuracy, dBs per degree, by increasing the distance between the two antennas 10 and 11, but as the separation increases, the number of possible angles of arrival for any DIFF value, increases. The method similar to that as described in FIG. 12 can be used to find the correct angle, but as the number of possibilities increases more measurement points may be required in order to distinguish the correct location of the source. The separation of the antennas 10 and 11 can be selected to suit the application or use case. If the range of the target transmitter is far, then a better accuracy may be the prime concern. The overall angle of arrival measurement accuracy will be affected by the accuracy of RSSI measurement. It should be clear to those skilled in the art that the arrangement of the antennas and the accuracy of the RSSI measurements can be chosen to fit a particular application or use case.

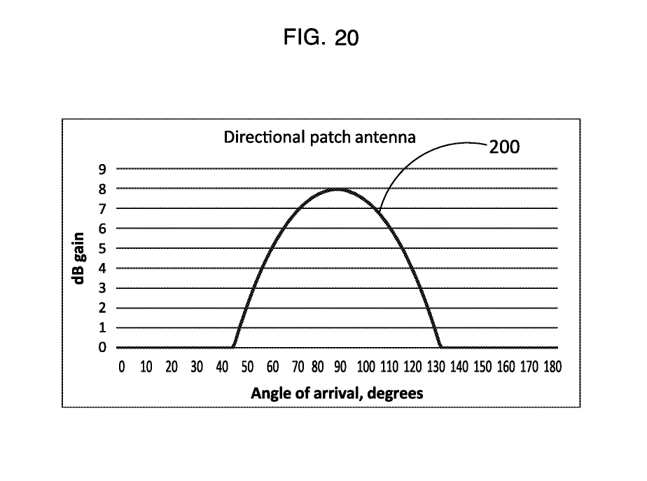

The analysis presented so far has assumed that antennas 10 and 11 have constant gain across the angles of arrival 0 to 180 degrees. Such omni-directional antennas could also have the same gain for angles of arrival 0 to 360 degrees. In order to distinguish the general direction of the source of the transmission, directional antennas may be used, for example, patch antennas. FIG. 20 is a graphical representation 200 of the gain of a standard patch antenna against the angle of arrival. In this case the patch antenna has a maximum gain of about 8 dBi and the boresight, 90 degrees, a 3 dB bandwidth of about 55 degrees, and is unidirectional, i.e. for angles of arrival 180 to 360 degrees, the gain is effectively 0 dB.

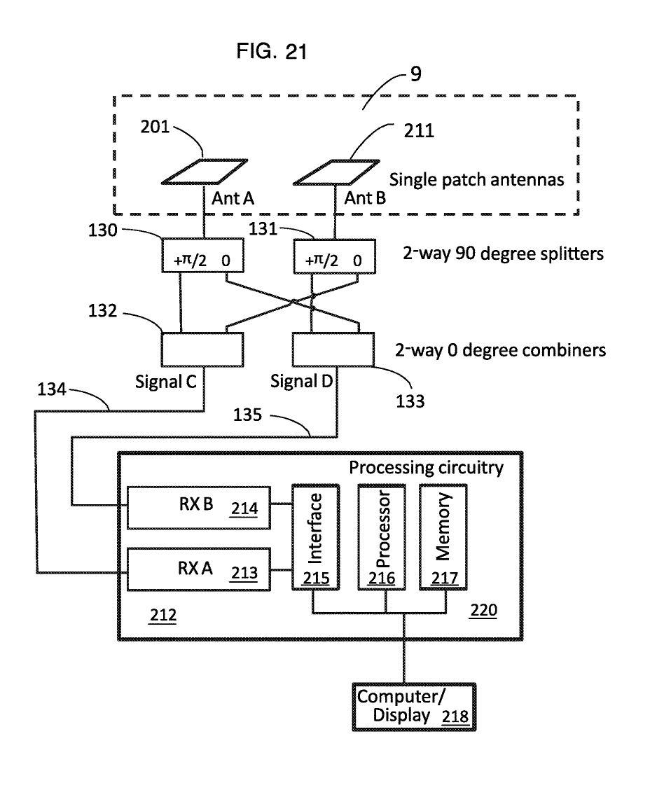

FIG. 21 is a diagrammatic representation of an embodiment of an example system comprising two patch antennas, 210 and 211, 2-way 90 degree splitters, 130 and 131, 2-way 0 degree combiners 132 and 133, producing signal C 134 and signal D 135 in a similar manner to that previously described above with respect to FIG. 13. RF receiver 212 may include two receivers, RX A 213 and RX B 214, an interface 215, and processing circuitry 220 including a processor 216 and memory 217. Signal C 134 is applied to the input of RX A 213 and signal D 135 is applied to the input of RX B 214. The RSSI for each of the signals C 134 and D 135 are measured by RX A and RX B respectively and outputted to the interface 215. The interface 215 and processing circuitry, e.g., processor 216 and memory 217, may be used to subtract the RSSI values of the signals C 134 and D 135, and produce the value for DIFF as described previously. The interface 215 and processing circuitry, e.g., processor 216 and memory 217, may also be used to calculate the effective output signal at either antenna 210 or 211. This calculation may be accomplished, for example, by converting the two RSSI values to milliwatts, adding them and then converting the value back to dBm. As described above with respect to FIG. 8 and FIG. 9, the peak values 86, 87, 96 and 97 are effected by the antenna output signal level. Hence, a knowledge of the signal level may be used to estimate the peak values and the effective flattening. An alternative is that receiver 212 comprises a third receiver chain and the output signal from either antenna 210 or 211 is input to this third receiver. This however may involve extra RF splitters to be used which may affect the overall sensitivity of the receive chain.

The conversion of the DIFF value to angles of arrival may be carried out in the processing circuitry 216 or in a computer/display block 218. As described above with respect to FIG. 11, one DIFF value may correspond to several possible angles of arrival and the true angle of arrival may be determined by a series of measurements as described in FIG. 12.

In one embodiment, the receiver 212 includes a processing circuitry such as the processor 216 and memory 217 in which the memory 217 stores instructions that, when executed by the processor 216, cause the processor 216 to perform functions described herein to determine the angles of arrival.

In addition to a traditional processor and memory, the processing circuitry of receiver 212 may include integrated circuitry for processing and/or control, e.g., one or more processors and/or processor cores and/or FPGAs (Field Programmable Gate Array) and/or ASICs (Application Specific Integrated Circuitry). The processor may be configured to access (e.g., write to and/or reading from) memory, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Such memory may be configured to store code executable by processor and/or other data, e.g., data pertaining to communication, e.g., configuration and/or address data of nodes, etc.

The processing circuitry of the receiver 212 may be configured to control any of the methods and/or processes described herein and/or to cause such methods and/or processes to be performed. Corresponding instructions may be stored in the memory 217, which may be readable and/or readably connected to processor 216.

The computer/display 218 may be used to carry out these calculations in order to determine the true angle of arrival. In one embodiment, the computer/display 218 includes a processing circuitry such as a processor and memory in which the memory stores instructions that, when executed by the processor, cause the processor to perform functions described herein to present data and information to a user and/or determine the angles of arrival. The display may be any display device suitable for presenting a user with the angle of arrival and other information.

In addition to a traditional processor and memory, processing circuitry may include integrated circuitry for processing and/or control, e.g., one or more processors and/or processor cores and/or FPGAs (Field Programmable Gate Array) and/or ASICs (Application Specific Integrated Circuitry). The processor may be configured to access (e.g., write to and/or reading from) memory, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Such memory may be configured to store code executable by processor and/or other data, e.g., data pertaining to communication, e.g., configuration and/or address data of nodes, etc.

The processing circuitry may be configured to control any of the methods and/or processes described herein and/or to cause such methods and/or processes to be performed, e.g., by the computer/display 218. Corresponding instructions may be stored in the memory, which may be readable and/or readably connected to processor.

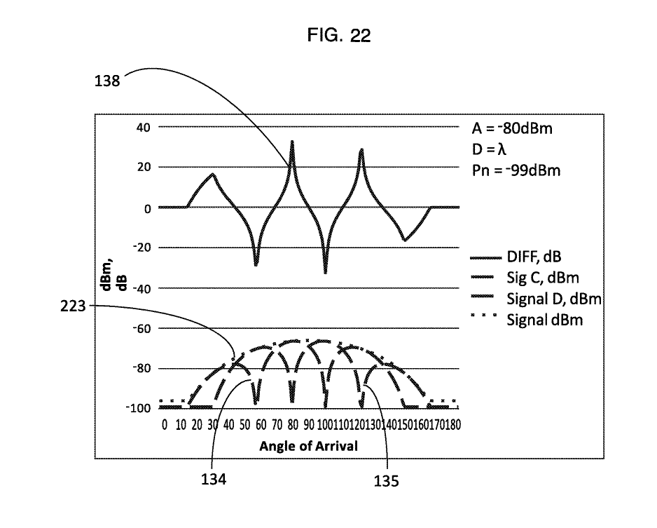

FIG. 22 is a graphical representation of the signal C 134, signal D 135, DIFF 138 and calculated input signal 223 values plotted against angle of arrival, when the amplitude of the incident signal A=−80 dBm, and the separation of the two antennas 210 and 211, is one wavelength, i.e. D=λ. The calculated input signal 223 shows the gain response of the directional patch antennas 210 and 211. Comparing FIG. 22 to FIG. 14 the effect of the gain and directivity of the patch antennas 210 and 211 can be noted.

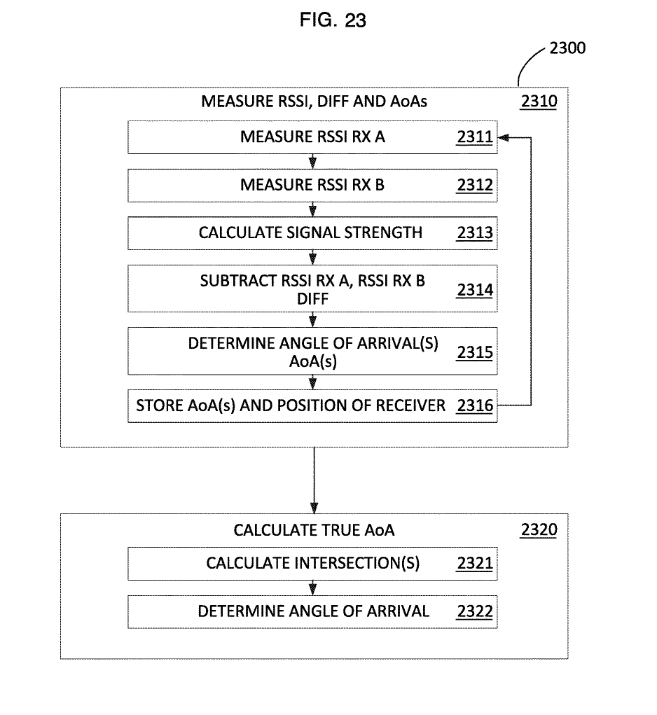

FIG. 23 illustrates an example method 2300 for determining an angle of arrival according to an embodiment of the disclosure. Method 2300 may include block 2310 where the RSSI values for signals C and D are measured via receivers 213 and 214, the difference between them, DIFF, calculated, via the processor 216 and the angles of arrival determined via the processor 216. Block 2310 may start with block 2311 where the RSSI value of signal C 134 at the input of RX A 213 is measured. Block 2311 may be followed by block 2312 where the RSSI value of signal D 135 at the input of RX B 214 is measured. Block 2312 may be followed by block 2313 where the RSSI of the signal at the output of either antenna 210 or 211 is calculated by combining the two RSSI values for signals C and D via the interface 215. Block 2313 may be followed by block 2314 where the value for DIFF is calculated, via the processor 216, by subtraction of the two RSSI values for signals C 134 and D 135. As previously described the RSSI values will generally be in dBm and a simple subtraction is the equivalent of the direct ratio of the signals. The DIFF value will be in dB and will be generally independent of the signal strengths of the input signal and output signals to and from the antennas as previously described in FIG. 8 and FIG. 9. Block 2314 may be followed by block 2315 where the DIFF value calculated in block 2314 is used, via the processor 216, to determine the possible angles of arrival of the signal at the antennas. As previously described in above with respect to FIGS. 11, 16, 17, 18 and 19, the number of possible angles of arrival will vary depending upon the separation of the two antennas. In the case where the antennas are separated by a distance of one wavelength there will be in general 4 possible angles of arrival for each DIFF value. Block 2315 may be followed by block 2316 where the position of the complete measuring receiving system receiver (212 and the antenna system 210, 211, 130, 131, 132, 133 and possibly computer/display 218) may be recorded along with the possible angles of arrival. The process then may return to block 2311.

Block 2310 may be followed by block 2320 where the true angle of arrival may be determined via the processor 216. Block 2320 may start with block 2321 where the intersections of various angle of arrival from different measurements and recordings performed in block 2310 are calculated via the processor 216. Block 2321 may be followed by block 2322 where the true angle of arrival is determined. As previously described above with respect to FIG. 12, if the position of the measuring receiver system changes, of if more than one measuring receiver system is used, then the true angle of arrival may be determined by noting the intersection of a pair of angles of arrival. In cases where there are more than one close intersection result, then, as described above with respect to FIG. 12, it is possible to use known information such as the elevation of the target in order to distinguish between the true intersection and spurious ones. This calculation may take place in block 2322 via the processor 216. The result of the determination of the true angle of arrival may be outputted to the computer/display 218 where the results may be further used for display and recording.

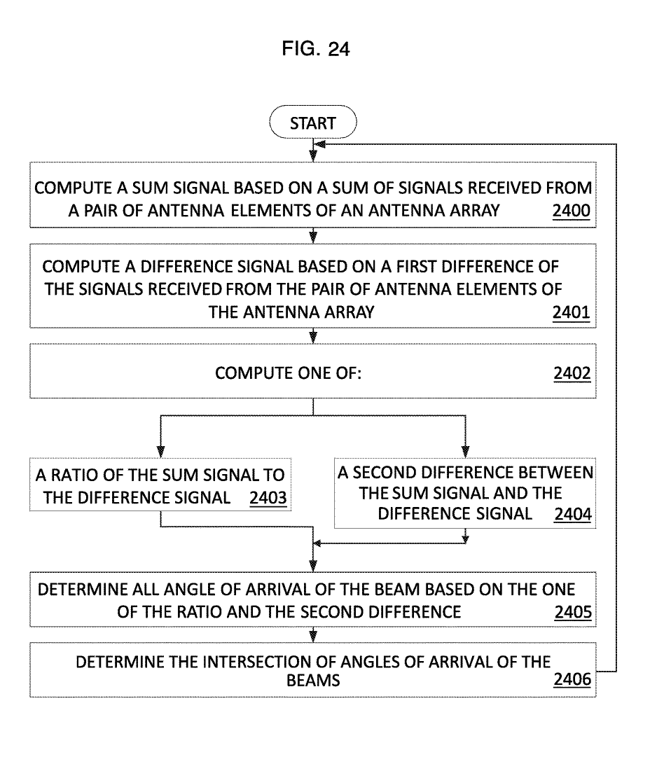

FIG. 24 is a flowchart of an exemplary process for determining an angle of arrival of a beam received at an antenna array 9. The process includes computing via an adder 21 a sum signal based on a sum of signals received from a pair of antenna elements 10, 11 of the antenna array 9 at block 2400. The process also includes computing via a subtractor 51 a difference signal based on a first difference of the signals received from the pair of antenna elements 10, 11 of the antenna array 9 at block 2401. At block 2402 the process includes computing one of: a ratio of the sum signal to the difference signal, via the divider 53, at block 2403; and a second difference between the sum signal and the difference signal, via the subtractor 75, at block 2404. The process also includes determining, via the processor 216, angles of arrival of the beam based on the one of the ratio and the second difference at block 2405. At block 2406, the intersection of the angles of arrival is determined from the angles of arrival of the beam determined in block 2405. The process then returns to block 2400.

Described above is a detailed explanation of embodiments using two antennas. It will be appreciated to a person of ordinary skill in the art that the method can be expanded and implemented with more than two antennas. In addition combinations of antenna pairs may be used to form antenna arrays 9 with a 360 degree coverage rather than the 180 degree coverage described. Different combinations of antenna spacing, antenna combining and combinations of such are almost limitless.

While the above description contains many specifics, these should not be construed as limitations on the scope, but rather as an exemplification of several embodiments thereof. Many other variants are possible including, for examples: various phasing and combining schemes, use of different antennas, use of more than two antennas, the use of a variety of antenna directivity, use of different measuring RF receiver schemes—number of receive chains, integral or separate processor(s), integral or separate computer and display(s), the use of various separations of the antennas. Accordingly the scope should be determined not by the embodiments illustrated, but by the claims and their legal equivalents.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A method for determining true angles of arrival of a beam received at an antenna array having a pair of antenna elements, the method comprising:
at each of a number of different positions of the antenna array:
computing a sum signal based on a sum of signals received from the pair of antenna elements of the antenna array;
computing a difference signal based on a first difference of the signals received from the pair of antenna elements of the antenna array;
computing one of:
a ratio of the sum signal to the difference signal; and
a second difference between the sum signal and the difference signal;
determining possible angles of arrival of the beam based on the one of the ratio and the second difference; and
determining an intersection of the possible angles of arrival for each of the number of different positions in order to determine the true angles of arrival.

2. The method of claim 1, wherein:
the sum signal is a first received signal strength indicator (RSSI) derived from the sum of the signals and the difference signal is a second RSSI derived from the first difference of the signals; and
the determined possible angles of arrival are based on the second difference.

3. The method of claim 1, wherein the sum signal and the difference signal are computed in decibels.

4. The method of claim 1, wherein determination of the possible angles of arrival involves computing the sum signal and the difference signal at different positions of the antenna array.

5. The method of claim 1, wherein determination of the possible angles of arrival involves computing the sum signal and the difference signal based on signals received from different pairs of antenna elements of the antenna array.

6. The method of claim 1, wherein:
the sum of signals is a first addition of a first output signal from a first antenna element of the pair of antenna elements shifted by zero degrees and a second output signal from a second antenna element of the pair of antenna elements shifted by zero degrees; and
the first difference of signals is a second addition of the first output signal from the first antenna element of the pair of antenna elements shifted by zero degrees and the second output signal from the second antenna element of the pair of antenna elements shifted by 180 degrees.

7. The method of claim 1, wherein:
the sum of signals is a first addition of a first output signal from a first antenna element of the pair of antenna elements shifted by zero degrees and a second output signal from a second antenna element of the pair of antenna elements shifted by zero degrees; and
the first difference of signals is a second addition of the first output signal from the first antenna element of the pair of antenna elements shifted by 90 degrees and the second output signal from the second antenna element of the pair of antenna elements shifted by minus 90 degrees.

8. An apparatus for determining true angles of arrival of a beam received at an antenna array having a pair of antenna elements, the apparatus comprising:
an adder configured to compute a sum signal based on a sum of signals received from the pair of antenna elements of the antenna array;
a subtractor configured to compute a difference signal based on a first difference of the signals received from the pair of antenna elements of the antenna array;
a processor configured to:
compute one of:
a ratio of the sum signal to the difference signal; and
a second difference between the sum signal and the difference signal; and
determine possible angles of arrival of the beam based on the one of the ratio and the second difference; and
determine an intersection of the possible angles of arrival for each of different positions of the antenna array in order to determine the true angles of arrival.

9. The apparatus of claim 8, wherein:
the sum signal is a received signal strength indicator (RSSI) derived from the sum of the signals and the difference signal is an RSSI derived from the first difference of the signals; and
the determined possible angles of arrival are based on the second difference.

10. The apparatus of claim 8, wherein the sum signal and the difference signal are computed in decibels.

11. The apparatus of claim 8, wherein determination of the possible angles of arrival involves computing the sum signal and the difference signal at different positions of the antenna array.

12. The apparatus of claim 8, wherein determination of the possible angles of arrival involves computing the sum signal and the difference signal based on signals received from different pairs of antenna elements of the antenna array.

13. The apparatus of claim 8, wherein:
the sum of signals is a first addition of a first output signal from a first antenna element of the pair of antenna elements shifted by zero degrees and a second output signal from a second antenna element of the pair of antenna elements shifted by zero degrees; and
the first difference of signals is a second addition of the first output signal from the first antenna element of the pair of antenna elements shifted by zero degrees and the second output signal from the second antenna element of the pair of antenna elements shifted by 180 degrees.

14. The apparatus of claim 8, wherein:
the sum of signals is a first addition of a first output signal from a first antenna element of the pair of antenna elements shifted by zero degrees and a second output signal from a second antenna element of the pair of antenna elements shifted by zero degrees; and
the first difference of signals is a second addition of the first output signal from the first antenna element of the pair of antenna elements shifted by 90 degrees and the second output signal from the second antenna element of the pair of antenna elements shifted by minus 90 degrees.

15. A radio frequency (RF) unit configured to determine true angles of arrival of a received beam, the RF unit comprising:
an antenna array having a plurality of antenna elements configured to receive the beam;
a first input circuit coupled to a first one of a pair of antenna elements to produce a first signal;
a second input circuit coupled to a second one of the pair of antenna elements to produce a second signal; and
a processor configured to:
determine one of a first difference and a ratio between the first and second signals to determine possible angles of arrival of the beam; and
determine an intersection of the possible angles of arrival for each of different positions of the antenna array in order to determine the true angles of arrival.

16. The RF unit of claim 15, wherein the first input circuit includes an adder to produce a sum of signals from the pair of antenna elements and the second input circuit includes a subtractor to produce a difference of signals from the pair of antenna elements.

17. The RF unit of claim 15, wherein:
the first input circuit comprises a first splitter configured to split a first signal received by a first antenna element into a first branch signal shifted by 90 degrees and a second branch signal shifted by zero degrees; and
the second input circuit comprises a second splitter configured to split a second signal received by a second antenna element into a third branch signal shifted by 90 degrees and a fourth branch signal shifted by zero degrees.

18. The RF unit of claim 17, wherein:
the first input circuit further comprises a first combiner configured to combine the first and fourth branch signals to produce a fifth signal having a sum of the first and second signals from the first and second antenna elements; and
the second input circuit further comprises a second combiner configured to combine the second and third branch signals to produce a sixth signal having a difference of the first and second signals from the first and second antenna elements.

19. The RF unit of claim 18, wherein:
the first input circuit further comprises a first receiver to produce a first received signal strength indicator (RSSI) based on the fifth signal; and
the second input circuit further comprises a second receiver to produce a second RSSI based on the sixth signal.

20. The RF unit of claim 19, wherein the processor is configured to determine a second difference between the first RSSI and the second RSSI.
